(19) United States
(12) Patent Application Publication
(10) Pub. No.: US 2021/0384593 A1
(43) Pub. Date: Dec. 9, 2021

(54) SECONDARY BATTERY

(71) Applicant: SAMSUNG SDI CO., LTD., Yongin-si, Gyeonggi-do (KR)

(72) Inventor: Jin Hwan KIM, Yongin-si (KR)

(21) Appl. No.: 16/606,674

(22) PCT Filed: Mar. 22, 2018
(86) PCT No.: PCT/KR2018/003329

§ 371 Date: Oct. 18, 2019

(30) Foreign Application Priority Data
May 22, 2017 (KR) 10-2017-0062924

(51) Int. Cl. H01M 50/533; H01M 50/15

(52) U.S. Cl. CPC H01M 50/533; H01M 50/15

(57) ABSTRACT

A pouch type secondary battery includes: an electrode assembly; a lead tab extending outwardly from the electrode assembly; and first and second covers for respectively covering one surface and the other surface of the electrode assembly, wherein the electrode assembly has a rectangular shaped outer periphery when viewed from the one or the other surface. The first and second covers are bonded along the periphery to seal the electrode assembly, and the inner periphery of the bonded region includes: a first straight portion neighboring a shorter side or a longer side of the electrode assembly; a second straight portion having a shorter length than the other side of the shorter and longer sides and contacts a point in the middle of the other side; and an inclined portion extending from the second straight portion and becomes away from the electrode assembly as it becomes away from the second straight portion.

### TECHNICAL FIELD

An embodiment of the present invention relates to a pouch type battery with improved safety.

### BACKGROUND ART

Secondary batteries, which can be repeatedly charged and discharged, include a nickel-cadmium (Ni—Cd) battery, a nickel-hydrogen (Ni—H) battery, a lithium battery, and so on. Among these secondary batteries, the lithium battery has an operation voltage of about 3.6V, which is almost three times higher than the operation voltages of the Ni—Cd battery and the Ni—H battery that have been widely used as power sources of electronic devices. In addition, the lithium battery has a high energy density per unit weight.

The lithium battery may be divided into a liquid electrolyte battery and a polymer electrolyte battery depending on the kind of an electrolyte. In general, the battery in which the liquid electrolyte is used is referred to as a lithium ion battery, and the battery in which the polymer electrolyte is used is referred to as a lithium polymer battery.

In addition, the lithium battery may be manufactured to have various shapes, and typical examples of the lithium battery include a cylinder type and a prismatic type, which are typically used for the lithium ion battery, and a pouch type, which is typically used for the lithium polymer battery. Specifically, the pouch type lithium battery includes an external case generally made of multiple layers including a metal foil and a synthetic resin covering the metal foil. Accordingly, the pouch type lithium battery is advantageous in that the battery weight is remarkably reduced, compared to the cylindrical or prismatic battery using a metal can.

The above information disclosed in this Background section is only for enhancement of understanding of the background of the described technology and therefore it may contain information that does not form the prior art that is already known in this country to a person of ordinary skill in the art.

### Technical Problem(s) to be Solved

The present invention has been made in an effort to solve the problems of the prior art, and it is an object of the present invention to provide a pouch type battery with improved safety.

### Technical Solution

An embodiment of the present invention provides a pouch type secondary battery with improved safety.

In accordance with an aspect of the present invention, the above and other objects can be accomplished by providing a secondary battery including an electrode assembly; a lead tab extending outward from the electrode assembly; a first cover for covering one surface of the electrode assembly; and a second cover for covering the other surface of the electrode assembly, wherein the electrode assembly has an outer periphery which has a rectangular shape when viewed from the one surface or the other surface; the first cover and the second cover are bonded along the periphery so as to seal the electrode assembly, and the inner periphery of the bonded region consists of: a first straight portion neighboring any one side from among a shorter side and a longer side of the electrode assembly; a second straight portion which is formed to have a shorter length than the other side from among the shorter side and the longer side of the electrode assembly and comes into contact with a point in the middle of the other side; and an inclined portion which extends from the second straight portion and becomes away from the electrode assembly as the inclined portion becomes away from the second straight portion.

The inner periphery of the bonded region may connect the first straight portion and the inclined portion and may further include a curved portion having a predetermined radius of curvature.

In addition, the lead tab may extend across the shorter side of the electrode assembly, the first straight portion may neighbor the shorter side of the electrode assembly, and the second straight portion may have a shorter length than the longer side of the electrode assembly to come into contact with the longer side.

In addition, a length (L₁) of the inclined portion, which is parallel with the shorter side of the electrode assembly, and a length (L₂) of the inclined portion, which is parallel with the longer side of the electrode assembly, may satisfy the following equation:

L₂=1 [mm]+2·L₁.

In addition, the L₁ and L₂ values may increase as the radius of curvature of the curved portion increases.

In addition, the length (L₂) of the inclined portion, which is parallel with the longer side of the electrode assembly, and a length (L₃) of the second straight portion, may satisfy the following expression of inequality:

L₃+1 [mm]≥2·L₂.

In addition, the length (L₁) of the inclined portion, which is parallel with the shorter side of the electrode assembly, the length (L₂) of the inclined portion, which is parallel with the longer side of the electrode assembly, and a length (L₃) of the second straight portion, may satisfy both of the following expressions:

L₂=1 [mm]+2L₁; and

L₃+1 [mm]≥2L₂.

### Advantageous Effects

As described above, according to an embodiment of the present invention, in the inner periphery of the bonded region of a battery case including the first cover and the second cover, the shape of an inner periphery portion being around a corner of the electrode assembly is specified to prevent interference between the inner periphery portion and the corner of the electrode assembly, thereby preventing the electrode assembly from being damaged when the first cover and the second cover are bonded.

### BRIEF DESCRIPTION OF DRAWINGS

FIG. 1 is a perspective view illustrating an assembled state of a secondary battery according to an embodiment of the present invention.

FIG. 2 is a perspective view illustrating a disassembled state of the secondary battery according to an embodiment of the present invention.

FIG. 3 is a plan view of a first cover of the secondary battery according to an embodiment of the present invention.

FIG. 4 is a partially enlarged view of FIG. 3.

FIG. 5 schematically illustrates a state in which interference between a curved portion and a corner of an electrode assembly occurs in the absence of an inclined portion.

FIG. 6 schematically illustrates a state in which interference between a curved portion and a corner of an electrode assembly is prevented in the presence of an inclined portion.

### BEST MODE FOR CARRYING OUT THE INVENTION

Hereinafter, a preferred embodiment of the present invention will be described in detail.

Various embodiments of the present invention may be embodied in many different forms and should not be construed as being limited to the example embodiments set forth herein. Rather, these example embodiments of the disclosure are provided so that this disclosure will be thorough and complete and will convey inventive concepts of the disclosure to those skilled in the art.

In the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present and the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “on” or “above” the other elements or features. Thus, the exemplary term “below” can encompass both an orientation of above and below.

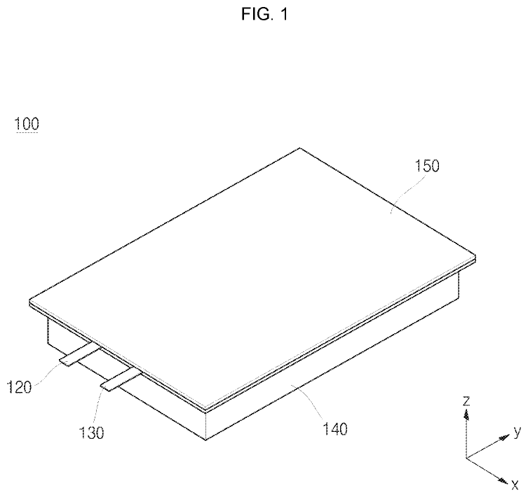

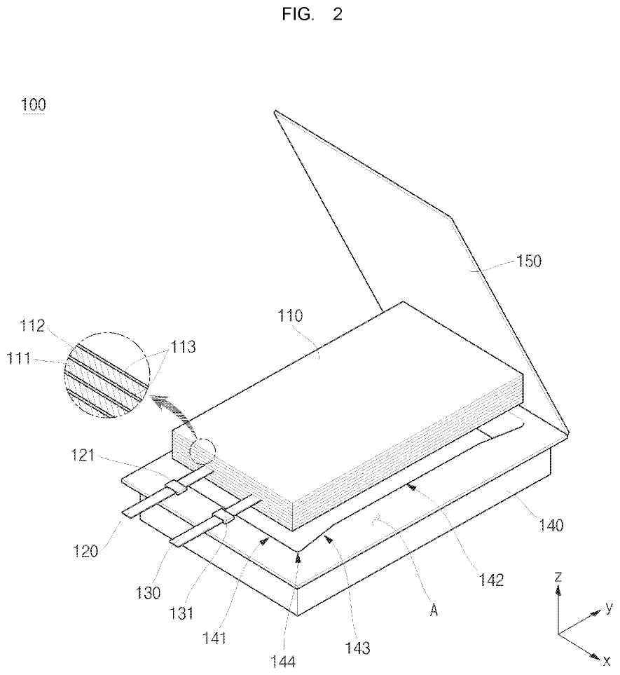

FIG. 1 is a perspective view illustrating an assembled state of a secondary battery 100 according to an embodiment of the present invention. FIG. 2 is a perspective view illustrating a disassembled state of the secondary battery 100 according to an embodiment of the present invention.

Referring to FIGS. 1 and 2, the secondary battery 100 includes an electrode assembly 110, a first lead tab 120, a second lead tab 130, a first cover 140 and a second cover 150.

First, the electrode assembly 110 includes a first electrode plate 111, a second electrode plate 112 and a separator 113 positioned between the first electrode plate 111 and the second electrode plate 112. Here, the electrode assembly 110 may be configured by winding a stacked structure including the first electrode plate 111, the separator 113, the second electrode plate 112 and the separator 113 arranged in that order, which is called a jelly-roll configuration or a stack configuration.

An outer periphery of the electrode assembly 110 may have a rectangular shape, when viewed in a Z-axis direction, irrespective of the configuration type of the electrode assembly 110.

Here, the first electrode plate 111 may operate as a positive electrode and the second electrode plate 112 may operate as a negative electrode. Of course, in some cases, the first electrode plate 111 may operate as a negative electrode and the second electrode plate 112 may operate as a positive electrode. For the sake of convenience, the following description will be made with regard to the former case by way of example.

The first electrode plate 111, that is, the positive electrode, generally includes a first electrode current collector made of a highly electrically conductive metal thin plate, e.g., an aluminum foil, and a first electrode active material coated on both surfaces of the first electrode current collector. In addition, the first electrode active material may include, for example, a transition metal oxide.

Meanwhile, a portion on which the first electrode active material is not coated, that is, a first non-coating portion, is located in the first electrode current collector. The first non-coating portion provides a current path between the first electrode plate 111 and the exterior side of the first electrode plate 111.

The first lead tab 120 located in the first non-coating portion extends outward. The first lead tab 120 serves as a path for inputting an external electrical signal to the first electrode plate 111 or outputting an electrical signal from the first electrode plate 111 to the exterior side of the first electrode plate 111.

Here, an insulation member 121 is attached to the first lead tab 120 to electrically insulate the first lead tab 120 from the first cover 140 and the second cover 150.

The second electrode plate 112, that is, the negative electrode, generally includes a second electrode current collector made of a highly electrically conductive metal thin plate, e.g., a nickel foil, and a second electrode active material coated on both surfaces of the second electrode current collector. In addition, the second electrode active material may include, for example, graphite or carbon.

Meanwhile, a portion on which the second electrode active material is not coated, that is, a second non-coating portion, is located in the second electrode current collector. The second non-coating portion provides a current path between the second electrode plate 112 and the exterior side of the second electrode plate 112.

The second lead tab 130 located in the second non-coating portion extends outward. The second lead tab 130 serves as a path for inputting an external electrical signal to the second electrode plate 112 or outputting an electrical signal from the second electrode plate 112 to the exterior side of the second electrode plate 112.

Here, an insulation member 131 is attached to the second lead tab 130 to electrically insulate the second lead tab 130 from the first cover 140 and the second cover 150.

The separator 113 may be positioned between the first electrode plate 111 and the second electrode plate 112 to prevent short-circuiting from occurring between the first and second electrode plates 111 and 112 and may allow lithium ions to move. The separator 113 generally includes, but not limited to, polyethylene, polypropylene, or a composite film of polyethylene and polypropylene.

Here, the separator 113 may have a larger width than the first electrode plate 111 or the second electrode plate 112 to more securely suppress short-circuiting occurring between the first and second electrode plates 111 and 112.

The electrode assembly 110 is accommodated with an electrolyte between the first cover 140 and the second cover 150. Here, the electrolyte may include a lithium salt, such as LiPF₆ or LibF₄, dissolved in an organic solvent, such as ethylene carbonate (EC), propylene carbonate (PC), diethyl carbonate (DEC), ethyl methyl carbonate (EMC), dimethyl carbonate (DMC).

Each of the first cover 140 and the second cover 150 may include multiple sheets. For example, each of the first cover 140 and the second cover 150 may consist of a polymer sheet for use in a surface facing the electrode assembly 110, i.e., an interior surface, to function for insulation and bonding, e.g., thermal fusion, a polyethyleneterephthalate (PET), nylon or PET-nylon sheet for use in an exterior surface, and a metal sheet, e.g., an aluminum sheet, positioned between the two sheets to provide a mechanical strength.

The first cover 140 mainly covers one surface of the electrode assembly 110 and provides a recessed space to stably accommodate the electrode assembly 110.

In addition, the second cover 150 mainly covers the other surface of the electrode assembly 110 and has a substantially planar surface to cover the recessed space of the first cover 140.

Conversely, the first cover 140 may be shaped of a plane and the second cover 150 may provide a recessed space. Alternatively, a recessed space may be provided in both of the first cover 140 and the second cover 150, respectively, for accommodating the electrode assembly 110.

Meanwhile, the first cover 140 and the second cover 150 are bonded along the periphery to seal the electrode assembly 110 and the electrolyte. Here, at least a portion of the inner periphery of the bonded region A comes into contact with the outer periphery of the electrode assembly 110, thereby preventing the electrode assembly 110 from moving in the internal space defined by the first cover 140 and the second cover 150. In addition, in the inner periphery of the bonded region A, a vertex, where a portion neighboring the shorter side (of a rectangle) of the electrode assembly 110 and a portion neighboring the longer side (of a rectangle) of the electrode assembly 110 meet, may have a predetermined radius of curvature. Accordingly, it is possible to prevent stress from concentrating around the vertex, thereby further increasing the durability of the secondary battery according to the present invention.

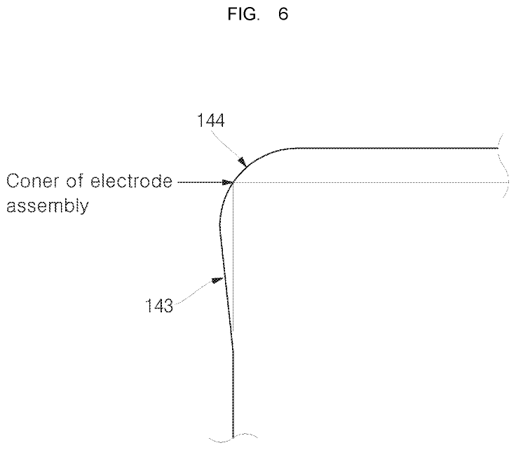

In this case, however, if the inner periphery of the bonded region A is just sized to correspond to the outer periphery of the electrode assembly 110, the vertex and the corner of the electrode assembly 110 may interfere with each other due to the predetermined radius of curvature of the vertex (see FIG. 5). Accordingly, when the first cover 140 and the second cover 150 are bonded along the periphery, interfered portions of the first electrode plate 111 and the second electrode plate 112 of the electrode assembly 110 may be folded or pressed, resulting in deformation. As a result, the separator 113 may be damaged to cause short-circuiting to the first electrode plate 111 and the second electrode plate 112, leading to ignition or explosion.

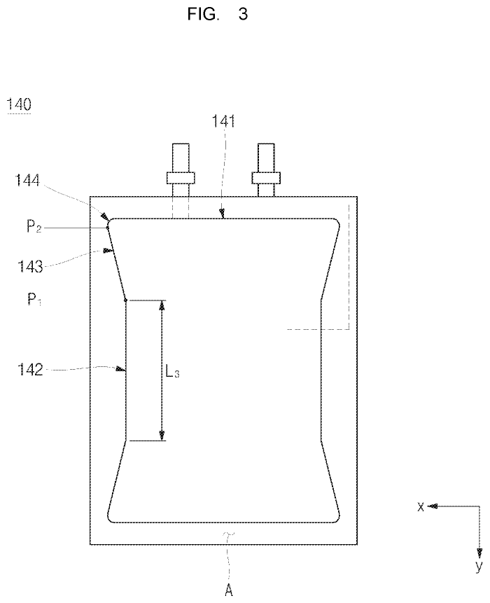

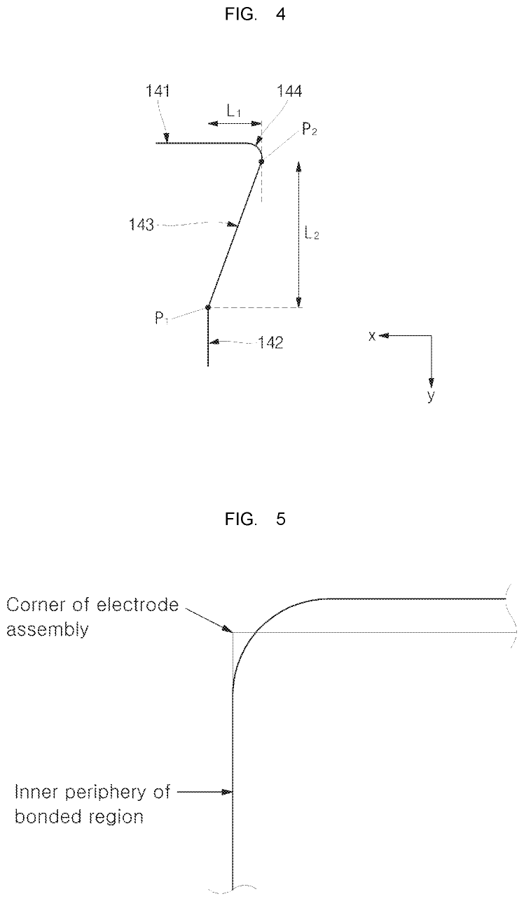

Therefore, as described above, in order to avoid the interference, the inner periphery of the bonded region A is configured to include a first straight portion 141, a second straight portion 142, an inclined portion 143 and a curved portion 144, which will be described in more detail with reference to FIGS. 3 and 4.

FIG. 3 is a plan view of a first cover 140 of the secondary battery 100 according to an embodiment of the present invention. FIG. 4 is a partially enlarged view of FIG. 3. In the drawings, sizes, angles or scales of various elements are exaggerated for convenience of explanation. Actual scales are based on the values represented by the following equation and tables.

Referring to FIGS. 3 and 4, in the inner periphery of the bonded region A, the first straight portion 141 may correspond to one side from among the shorter sides and the longer side sides in the outer periphery of the electrode assembly 110 and may neighbor (or adjoin) said one side. For convenience of explanation, the following description will be given by way of example with regard to a case where the first straight portion 141 corresponds to the shorter side of the electrode assembly 110 and neighbors the shorter side, as shown.

Although only one location is denoted by reference numeral 141 indicating the first straight portion, it will be understood that the first straight portion 141 is provided at two facing locations in the inner periphery of the bonded region A, respectively.

In addition, the term “straight line” used herein is intended to mean that the straight line is generally inclusive of a straight zone so as to correspond to the shorter side of the electrode assembly 110, but is not intended to be exclusive and mean that the first straight portion 141 is necessarily a straight line in a strict sense as defined in commonly used dictionaries. The same is true for the second straight portion 142.

The second straight portion 142 has a shorter length than the other side from among the shorter side and the longer side in the outer periphery of the electrode assembly 110 and comes into contact with a substantially middle point of said the other side. As stated above, if the first straight portion 141 corresponds to the shorter side of the electrode assembly 110 and neighbors the shorter side, the second straight portion 142 may have a shorter length than the longer side of the electrode assembly 110 to then come into contact with a substantially middle point of the longer side.

Accordingly, the electrode assembly 110 may be supported by the second straight portion 142, and the electrode assembly 110 may be prevented from moving across the longer side in the internal space defined by the first cover 140 and the second cover 150.

The second straight portion 142 is also shown at only one location in the drawings, but it will be understood that the second straight portion 142 is also provided at two facing locations in the inner periphery of the bonded region A.

The inclined portion 143 extends from an end point P₁ of the second straight portion 142. Here, the inclined portion 143 becomes away from the electrode assembly 110 as it becomes away from the end point P₁ of the second straight portion 142. Eventually, the inclined portion 143 may have a predetermined slope with respect to the longer side of the electrode assembly 110. Accordingly, a clearance may be created between the inclined portion 143 and the longer side of the electrode assembly 110. The clearance will be gradually increased as the inclined portion 143 becomes away from the end point P₁ of the second straight portion 142.

The inclined portion 143 is provided at opposite sides of the second straight portion 142, and it will be understood that the inclined portion 143 is provided at four locations in the inner periphery of the bonded region A.

The curved portion 144 connects the first straight portion 141 with the inclined portion 143. Here, the curved portion 144 has a predetermined radius of curvature.

If the curved portion 144 is provided in such a manner, the inner periphery of the bonded region A may be reduced, compared to a case where the first straight portion 141 and the inclined portion 143 straightly meet each other. However, unlike in the conventional case (FIG. 5), the inclined portion 143 may create the clearance between the inclined portion 143 and the longer side of the electrode assembly 110, providing the curved portion 144. Accordingly, even if the inner periphery of the bonded region A is slightly reduced, the curved portion 144 and the corner of the electrode assembly 110 may not interfere with each other (see FIG. 6).

Meanwhile, assuming that an X-axis direction length of the inclined portion 143, which is parallel with the shorter side of the electrode assembly 110, that is, a distance between the end point P₁ of the second straight portion 142 and a point P₂ where the inclined portion 143 and the curved portion 144 meet each other, is denoted by “L₁”, and a Y-axis direction length of the inclined portion 143, which is parallel with the longer side of the electrode assembly 110, that is, the distance between the end point P₁ of the second straight portion 142 and the point P₂ where the inclined portion 143 and the curved portion 144 meet each other, is denoted by “L₂”, L₁ and L₂ may satisfy the following equation (1):

L₂=1 [mm]+2·L₁ (1)

That is to say, L₁ and L₂ values may be determined as values summarized in Table 1.

TABLE 1

| L₁ [mm] | L₂ [mm] |
|---|---|
| 0.05 | 1.10 |
| 0.10 | 1.20 |
| 0.15 | 1.30 |
| 0.20 | 1.40 |
| 0.25 | 1.50 |
| 0.30 | 1.60 |
| 0.35 | 1.70 |
| 0.40 | 1.80 |
| 0.45 | 1.90 |
| 0.50 | 2.00 |

If the L₁ value is unduly smaller than the L₂ value, the clearance may not be sufficient to effectively prevent the curved portion 144 and the corner of the electrode assembly 110 from interfering with each other.

However, if the L₁ value is unduly larger than the L₂ value, an area of the bonded region A may be reduced, making it difficult to properly maintain a bonding strength between the first cover 140 and the second cover 150. In addition, an increased extent of bending between the second straight portion 142 and the inclined portion 143 may result in stress concentration around the end point P₁ of the second straight portion 142.

The above-stated problems can be addressed by determining appropriate L₁ and L₂ values satisfying the Equation (1).

When the L₁ and L₂₀ values have given values, the inner periphery of the bonded region A will be further reduced as the radius of curvature of the curved portion 144 increases. Accordingly, if the inner periphery of the bonded region A is unduly reduced with the unduly increasing radius of curvature of the curved portion 144. the curved portion 144 and the corner of the electrode assembly 110 may interfere with each other in some cases.

Therefore, in order to more securely suppress interference between the curved portion 144 and the corner of the electrode assembly 110, the L₁ and L₂ values may be increased as the radius of curvature of the curved portion 144 increases. Examples of the determined L₁ and L₂ values are listed in Table 2.

TABLE 2

| R [mm] | L₁ [mm] | L₂ [mm] |
|---|---|---|
| 0.5 | 0.05 | 1.10 |
| | 0.10 | 1.20 |
| | 0.15 | 1.30 |
| | 0.20 | 1.40 |
| | 0.25 | 1.50 |
| | 0.30 | 1.60 |
| | 0.35 | 1.70 |
| | 0.40 | 1.80 |
| | 0.45 | 1.90 |
| | 0.50 | 2.00 |
| 1.0 | 0.55 | 2.10 |
| | 0.60 | 2.20 |
| | 0.65 | 2.30 |
| | 0.70 | 2.40 |
| | 0.75 | 2.50 |
| | 0.80 | 2.60 |
| | 0.85 | 2.70 |
| | 0.90 | 2.80 |
| | 0.95 | 2.90 |
| | 0.10 | 3.00 |
| 1.5 | 0.15 | 3.10 |
| | 0.20 | 3.20 |
| . . . | . . . | . . . |

In addition, when a length of the second straight portion 142 is denoted by “L₃”, L₂ and L₃ may satisfy the following expression of inequality (2):

L₃+1 [mm]≥2·L₂ (2)

Accordingly, an area of greater than a predetermined dimension, which contacts the longer side of the electrode assembly 110, may be secured in the inner periphery of the bonded region A, thereby ensuring an appropriate function of the second straight portion 142 in preventing the electrode assembly 110 from moving across the longer side of the electrode assembly 110.

While the secondary battery of the present invention has been particularly shown and described with reference to exemplary embodiments thereof, it will be understood by those of ordinary skill in the art that various changes in form and details may be made therein without departing from the spirit and scope of the present invention as defined by the following claims.

1. A secondary battery comprising:
an electrode assembly;
a lead tab extending outward from the electrode assembly;
a first cover for covering one surface of the electrode assembly; and
a second cover for covering the other surface of the electrode assembly,
wherein the electrode assembly has an outer periphery which has a rectangular shape when viewed from the one surface or the other surface; the first cover and the second cover are bonded along the periphery so as to seal the electrode assembly, and the inner periphery of the bonded region consists of: a first straight portion neighboring any one side from among a shorter side and a longer side of the electrode assembly; a second straight portion which is formed to have a shorter length than the other side from among the shorter side and the longer side of the electrode assembly and comes into contact with a point in the middle of the other side; and an inclined portion which extends from the second straight portion and becomes away from the electrode assembly as the inclined portion becomes away from the second straight portion.

2. The secondary battery of claim 1, wherein the inner periphery of the bonded region connects the first straight portion and the inclined portion and further includes a curved portion having a predetermined radius of curvature.

3. The secondary battery of claim 2, wherein the lead tab extends across the shorter side of the electrode assembly, the first straight portion neighbors the shorter side of the electrode assembly, and the second straight portion has a shorter length than the longer side of the electrode assembly to come into contact with the longer side.

4. The secondary battery of claim 3, wherein a length (L₁) of the inclined portion, which is parallel with the shorter side of the electrode assembly, and a length (L₂) of the inclined portion, which is parallel with the longer side of the electrode assembly, satisfy the following equation:
L₂=1 [mm]+2·L₁.

5. The secondary battery of claim 4, wherein the L₁ and L₂ values increase as the radius of curvature of the curved portion increases.

6. The secondary battery of claim 3, wherein the length (L₂) of the inclined portion, which is parallel with the longer side of the electrode assembly, and a length (L₃) of the second straight portion, satisfy the following expression of inequality:
L₃+1 [mm]≥2·L₂.

7. The secondary battery of claim 3, wherein the length (L₁) of the inclined portion, which is parallel with the shorter side of the electrode assembly, the length (L₂) of the inclined portion, which is parallel with the longer side of the electrode assembly, and a length (L₃) of the second straight portion, satisfy both of the following expressions:
L₂=1 [mm]+2L₁; and
L₃+1 [mm]≥2L₂.
